(19) United States
(12) Patent Application Publication
(10) Pub. No.: US 2006/0168629 A1
(43) Pub. Date: Jul. 27, 2006

(54) Digitized wireless remote control apparatus and method for personal video recorder

(75) Inventors: Shih-Hsiung Weng, Taipei City (TW); Chee-Yen Ool, Penang (MY)

Correspondence Address: HDSL, 4331 STEVENS BATTLE LANE, FAIRFAX, VA, 22033, US

(73) Assignee: Inventec Multimedia & Telecom Corporation

(21) Appl. No.: 11/043,127

(22) Filed: Jan. 27, 2005

(51) Int. Cl. H04N 7/18; H04N 5/44; G06F 13/00; G06F 3/00

(52) U.S. Cl. 725/81; 725/37; 348/734

(57) ABSTRACT

A digitized wireless remote control apparatus and method for a personal video recorder is disclosed. It uses a multimedia viewer to log in a username and password in a personal video recorder, and uses a digitized wireless remote control to provide a command for executing data download, copying, editing, printing or history checking of a personal video recorder.

### BACKGROUND

1. Field of the Invention

The present invention relates to a digitized wireless remote control apparatus and method for a personal video recorder (PVR).

2. Related Art

Currently, the personal video recorder is controlled by infrared remote control, which is only effective within a certain distance. If the remote control and the personal video recorder are distant beyond the effective range, the remote control cannot be used to control or operate the personal video recorder.

To resolve the distance restriction, Internet has been used to control the personal video recorder in industry. The control by Internet has to be performed through a personal computer. If the user is staying outdoors, or when the personal computer or laptop computer used to connect the Internet is not available, the personal video recorder cannot be controlled by the internet either.

Therefore, there exists a substantial need to provide a method and an apparatus for replacing or improving the existing conventional remote control method.

### SUMMARY

A digitized wireless remote control apparatus and a method for a personal video recorder are provided to replace the conventional infrared remote control or Internet.

As provided, the digitized wireless remote control apparatus and method use a multimedia viewer to transmit a signal to the personal video recorder to request establishment of communication. When the personal video recorder receives the signal and is busy or offline, the request for communication is rejected. Otherwise, the request is accepted, and the communication is established.

In one embodiment, the busy state can be categorized into a high-level busy state and a low-level busy state. Under the high-level busy state, the communication with the multimedia viewer is rejected. When the personal video recorder is in the low-level busy state, the communication may be accepted with a lower processing speed compared to a normal processing speed, used when the personal video recorder is not in a busy state at all.

When the connection is accepted, a request for inputting the username and password in the multimedia viewer is generated by the personal video recorder. The personal video recorder can then verify the input user name and password.

When the username and password are incorrect or do not match the data pre-stored in the personal video recorder or when the username and password do not match with each other, the communication has to be re-established. On the contrary, when the username and password match, the user can control operation of the personal video recorder by the remote control without inputting the username and password again.

In one embodiment, the wireless remote control can generate various command signals to the personal video recorder for executing corresponding functions, including the downloading function, copying function, printing function, editing function or history checking function. When the user no longer wants to use the personal video recorder, the user can log off the communication through the multimedia viewer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus does not limit the present invention, wherein:

FIG. 1 is a process flow showing the method of using a multimedia viewer, to digitally and wirelessly remote control a personal video recorder;

FIG. 2 is a process flow showing the method of using a multimedia viewer to transmit a command for executing the downloading function of the personal video recorder;

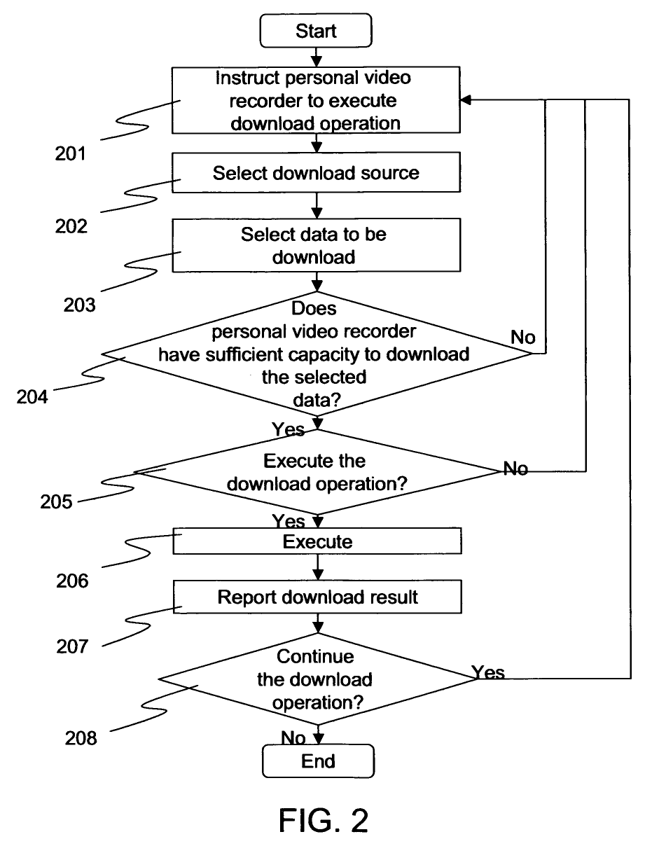

FIG. 3 is a process flow showing the method of using a multimedia viewer to transmit a command for executing the printing function of the personal video recorder;

FIG. 4 is a process flow showing the method of using a multimedia viewer to transmit a command for executing the printing function of the personal video recorder;

FIG. 5 is a process flow showing the method of using a multimedia viewer to transmit a command for executing the editing function of the personal video recorder;

FIG. 6 is a process flow showing the method of using a multimedia viewer to transmit a command for executing the history checking function of the personal video recorder;

FIG. 7 is a block diagram showing a personal video recorder; and

FIG. 8 is a block diagram showing a multimedia viewer.

### DESCRIPTION

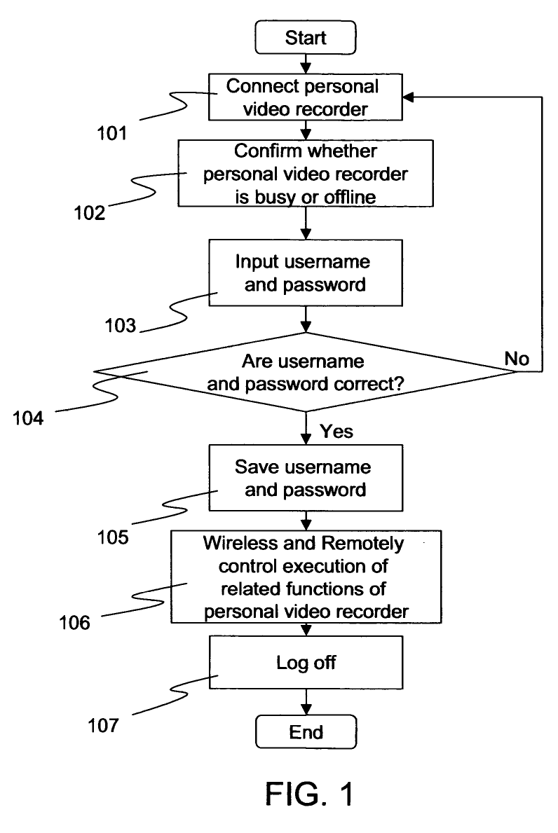

Referring to FIG. 1, a method of using a multimedia viewer for a digitized wireless remote control to control a personal video recorder is illustrated. The method includes the following steps.

In step 101, the personal video recorder is connected. The connection is initiated by transmitting a signal for requesting connection from the multimedia viewer to the personal video recorder.

In step 102 is determined, whether the personal video recorder is busy or offline. Upon reception of the connection signal, the personal video recorder rejects the request when it is busy or offline. Otherwise, the connection is accepted. In an alternate embodiment, the busy state is categorized into a high-level busy state and a low-level busy state. In the high-level busy state, the connection is rejected, while in the low-level busy state, the connection may be accepted with a relatively low processing speed.

When the request for connection is accepted, in step 103, the personal video recorder will send a request for the user to input the username and password through the multimedia viewer for identification.

The input username and password are then verified in step 104. If the input username and password are incorrect or do not match with each other or the data pre-stored in the personal video recorder, the connection has to be re-established, and the process has to start again from step 101.

If the username and password are correct, the input username and password are saved (step 105), and the communication between the remote control and the personal video recorder is established, allowing the user to control operations of the personal video recorder via the remote control. Before the user logs off the connection, the step of inputting the username and password is not required.

In step 106, the wireless remote control is used to execute various operation functions of the personal video recorder via the multimedia viewer. That is, via the multimedia viewer, various commands, such as executing the downloading function, copying function, printing function, editing function and history checking function can be transmitted to the personal video recorder.

When the user no longer wants to operate the personal video recorder, in step 107, the user can log off the connection between the multimedia viewer and the personal video recorder.

When the multimedia viewer transmits a command for executing the downloading function, the personal video recorder performs the following processing steps.

In step 201, the personal video recorder receives the download command to initiate the download operation.

A downloading source is selected in step 202. Via the multimedia viewer, the user selects the downloading source from the Internet, the television channel or other sources.

Downloading data are then selected from the downloading source in step 203 after selecting the downloading source.

In step 204 is determined whether the memory capacity of the personal video recorder is sufficient for downloading the selected downloading data. Preferably, the personal video recorder includes a hard disk to record the selected downloading data. The capacity of the hard disk is preferably larger than the selected downloading data to execute the downloading function. If the hard disc has insufficient capacity, the downloading operation is interrupted, and the process returns to step 201.

In step 205 is reconfirmed whether the downloading function is to be executed. Again, if the capacity of the personal video recorder is sufficient, the downloading operation is confirmed. If the capacity of the personal video recorder is smaller than the selected downloading data, the multimedia viewer cancels the download command and the process returns to step 201.

When the download command is reconfirmed in step 205, the downloading operation is executed in step 206. That is, when the multimedia device confirms the download operation, the operation is executed.

The downloading result is reported in step 207. When the downloading operation is complete, the downloading result is transmitted to the multimedia viewer.

In step 208 is confirmed whether the downloading operation is to be continued. That is, whether the download operation should be continued is determined by the multimedia. If not, the process ends and if yes, the process returns to step 201.

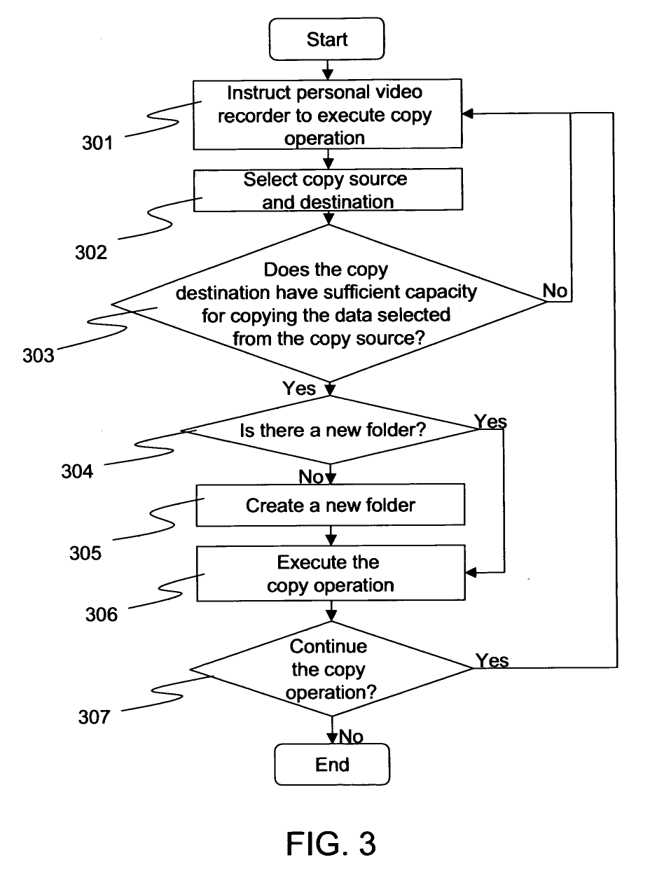

In FIG. 3, the copying operation of the personal video recorder is illustrated.

In step 301, the user uses the remote control to select the copy function, and transmits a copy command to the personal video recorder through the multimedia viewer.

In step 302, the user selects the copy source and destination. For example, the user may select data from the personal video recorder to be copied to the multimedia viewer or from the multimedia viewer to be copied to the personal video recorder.

In step 303, whether the destination to which the selected data will be copied has sufficient capacity is confirmed. That is, whether the remaining capacity of the personal video recorder or the multimedia viewer that is sufficient for copying the selected data is confirmed. If the remaining capacity is smaller than the selected data, the copy operation is interrupted, and the process returns to step 301.

In step 304, whether a new folder is to be opened is confirmed. When the destination is confirmed to have sufficient capacity for copying the selected data in step 303, whether the new folder is established for saving the copied selected data is further confirmed. If there is a new folder existed, the copying operation is executed directly.

In step 305, the new folder is opened. When it has been confirmed that the copied data are to be saved in the new folder, a new folder is opened in the destination.

In step 306, the copy operation is executed, that is, the copy operation is performed between the personal video recorder and the multimedia viewer.

Whether the copy operation is continuously executed is confirmed in step 307. That is, whether the copy operation is continued by the multimedia viewer. If not, the copy operation of the personal video recorder is terminated. If yes, the process to step 301.

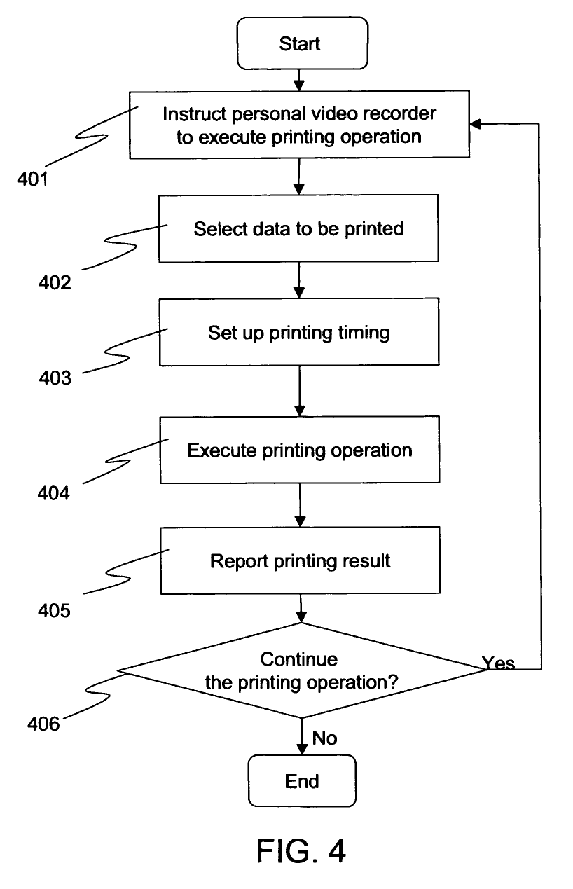

FIG. 4 shows the steps of using the multimedia viewer to control the printing function of the personal video recorder.

In step 401, the multimedia viewer transmits a signal carrying a printing command to the personal video recorder.

The user can select the data to be printed via the multimedia viewer in step 402. The data to be panted may be selected from the multimedia viewer or the personal video recorder.

The printing time is set up in step 403. That is, the multimedia viewer is used to select a specific time to execute the printing operation, or to execute the printing operation immediately.

According to the timing set up via the multimedia viewer, the personal video recorder executes the printing operation in step 404.

In step 405, the printing result is transmitted from the personal video recorder to the multimedia viewer.

Whether the printing operation is to be continued is confirmed in step 406. That is, the multimedia viewer determines whether the printing operation is continued. If not, the printing operation is terminated. If the printing operation is to be continued, the process starts again from step 401.

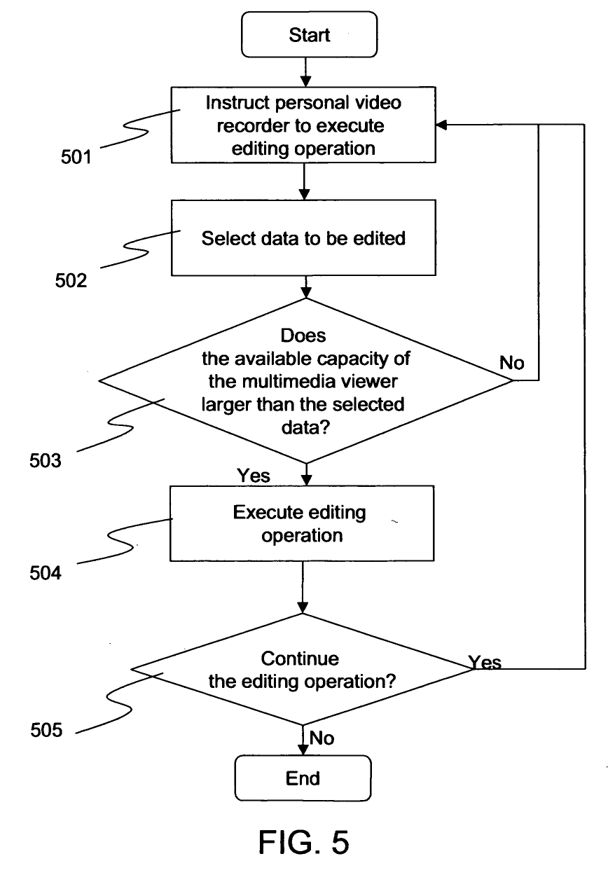

FIG. 5 shows the steps of using the multimedia viewer to control the editing function of the personal video recorder.

In step 501, the multimedia viewer transmits an edit command to the personal video recorder.

The multimedia viewer then selects the data to be edited from the personal video recorder in step 502.

Whether the capacity of the multimedia viewer is larger than the selected data is confirmed in step 503. That is, whether the multimedia viewer has sufficient capacity for editing the selected data is determined. If the capacity of the multimedia viewer is insufficient for editing the selected data, the edit operation is interrupted, and the process goes back to step 501.

In step 504, the editing operation is executed. If the multimedia viewer has sufficient available capacity, the editing option is commenced.

In step 505 is confirmed whether the editing operation is to be continued. That is, the multimedia determines continuation of the editing operation. If the user does not want to continue editing, the editing operation is terminated, and the process returns to step 501.

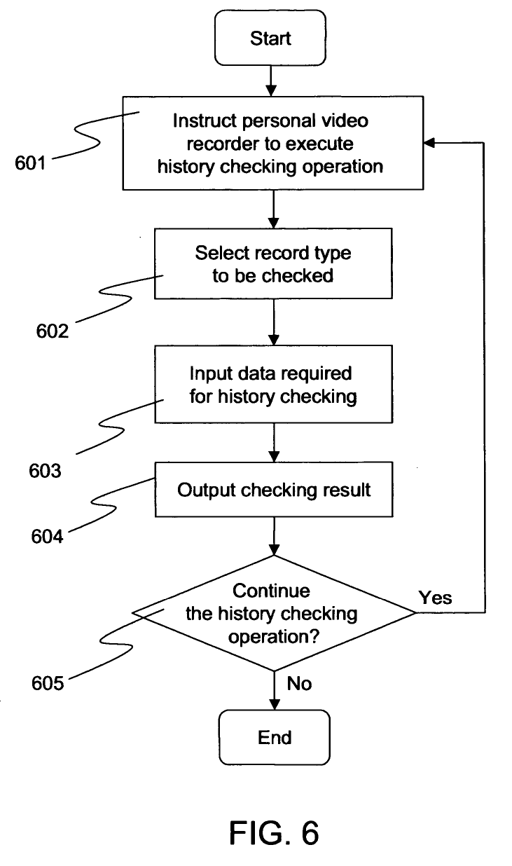

FIG. 6 shows the steps of using the multimedia viewer to control the history function of the personal video recorder.

To initiate the history checking operation, the multimedia viewer transmits a history checking command to the personal video recorder in step 601.

In step 602, the multimedia viewer selects the type of data history to be checked, such as the download record, copying record, editing record or printing record of the data.

The data of the record to be checked is input by the multimedia viewer in step 603.

In step 604, the checked history is output. That is, the personal video recorder outputs the checking result to the multimedia viewer. The checking results may include the title of the data, the capacity of the data, the last update date of the data, the source of the data, and the destination of the data or other related information of the data.

Whether the history checking operation is to be continued is confirmed in step 605. That is, in this step, the multimedia viewer determines whether the history checking operation is to be continued or not. If not, the history checking operation is terminated. If further history checking operation is to be continued, the process starts again from step 601.

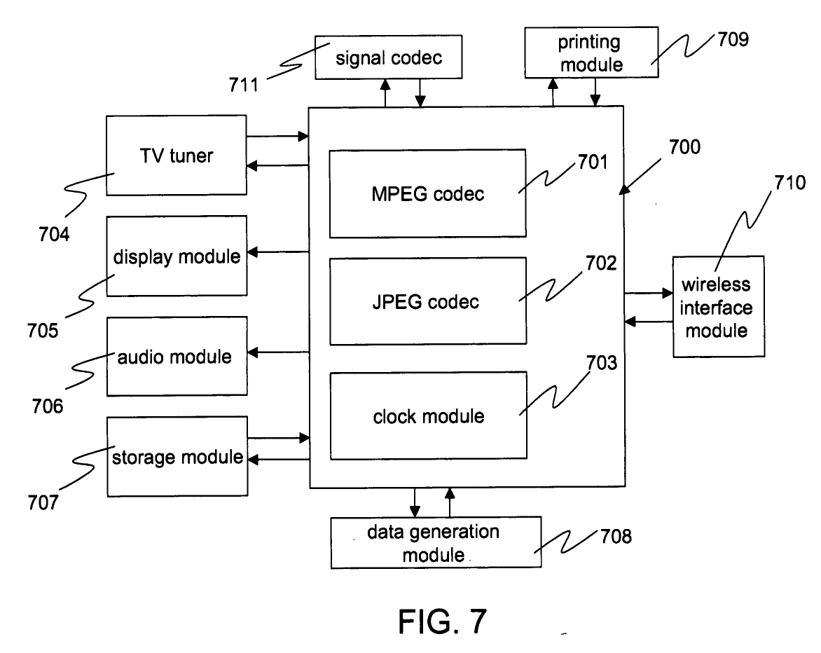

FIG. 7 illustrates an embodiment of the personal video recorder.

As shown, the personal video recorder includes a cents processing unit 700 for processing and executing the operations of the personal video recorder. The central processing unit 700 includes an MPEG codec 701, a JPEG codec 702 and a clock module 703. The MPEG codec 701 decodes and outputs an input image signal, the JPEG codec 702 decodes and outputs a graphic signal and the clock module 703 coordinates the operation of the central processing unit 700.

The personal video recorder also comprises a TV tuner 704, a display module 705, an audio module 706, a storage module 707, a data generating module 708, a printing module 709, a wireless interface module 710, and a signal codec 711.

The TV tuner 704 is operative to receive TV channel signals transmitted by satellites, the display module 705 is used to display the signals output from the central processing unit 700 in the form of image or graph. The audio module 706 is used to input and output audio signals and the storage module 707 is responsible for data storage. The data-generating module 708 generates data requested by the central processing unit. The module 709 is used for data printing. The wireless interface module 710 is used to receive and transmit wireless signals. The signal codec 711 is used to decode a signal input from the multimedia viewer, or encodes a signal to be output to the multimedia viewer.

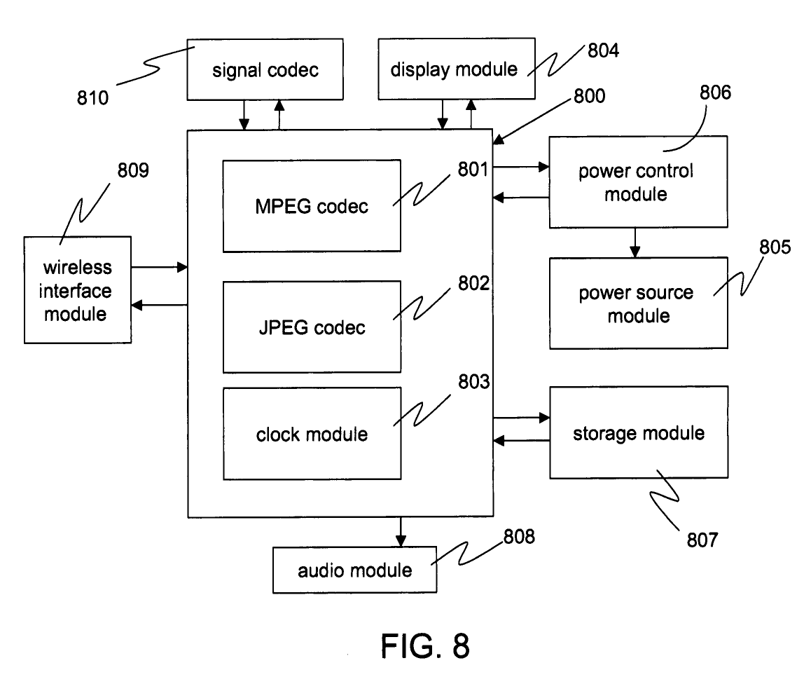

FIG. 8 inmates the multimedia viewer.

As shown, the multimedia viewer includes a central processor for processing the operations of the multimedia viewer. The central processor 800 comprises a MPEG codec 801, a JPEG codec 802 and a clock module 803. The MPEG codec 801 decodes an input image signal and outputs the decoded signal. The JPEG codec 802 decodes an input graphic signal and outputs the decoded signal. The clock module 803 is responsible for coordinating operations of the central processing unit 800.

The multimedia viewer further comprises a display module 804, a power module 805, a power source control module (SCPU) 806, a storage module 807, an audio module 808, a wireless interface module 809, and a signal codec 810.

The display module 804 is used to display the signal output from the central processor 800 in the form of an image or graph. The power source module 805 is operative to supply the power, typically direct current, of the multimedia viewer. The power control module 806 is responsible for controlling power output by the power source module 805. The storage module 807 is used for storing data of the multimedia viewer The audio module 808 is used to input and output audio signals. The wireless interface module 809 is used to receive and transmit wireless signals. The signal codec 810 is used to decode a signal input from the personal video recorder, or encodes a signal to be output to the personal video recorder.

The communication between the multimedia inspection and the personal video recorder is established by outputting a connection signal from the wireless interface module 809 of the central processor 800 of the multimedia viewer to the wireless interface module 710 of the personal video recorder. When the wireless interface module 710 receives the connection signal, the central processor 700 transits a signal via the multimedia viewer to the wireless interface module 710 for requesting subsequent signals. When the subsequent signals are output from the signal codec 810 of the multimedia viewer and transmitted to the personal video recorder through the wireless interface modules 809 and 710, the central processor 700 transmits the signal to the signal codec 711, allowing the signal input from the multimedia inspection device to be decoded and transmitted back to the central processor 700 and saved in the storage module 707.

Knowing the invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digitized wireless remote control method for a personal video recorder, using a multimedia viewer to digitally and wirelessly remote control the personal video recorder, comprising the following steps:
(a) connecting the personal video recorder;
(b) confirming connection to the personal video recorder being allowed;
(c) inputting a connection data;
(d) confirming the connection data being correct;
(e) wirelessly and remote controlling the personal video recorder to execute at least one of a plurality of operation functions; and
(f) interrupting the connection to the personal video recorder.

2. The method of claim 1, wherein step (b) includes rejecting the connection when the personal video recorder is offline.

3. The method of claim 1, wherein step (b) includes rejecting the connection when the personal video recorder is busy.

4. The method of claim 1, wherein step (b) includes allowing the connection with a processing speed lower than that allowed for an idle state.

5. The method of claim 1, wherein the connection data includes a username and a password.

6. The method of claim 1, wherein step (d) includes returning to step (a) for reconnecting the personal video recorder when the input connection data is incorrect.

7. The method of claim 1, wherein steps (d) and (e) further include saving the connection data without re-inputting the connection.

8. The method of claim 1, wherein when step (e) includes instructing the personal video recorder to perform download operation, step (e) further comprises:
instructing the personal video recorder to execute download operation;
selecting a download source;
selecting a download data;
confirming the personal video recorder having sufficient storage capacity for the download data;
executing download operation.

9. The method of claim 1, wherein when the multimedia viewer instructs the personal video recorder to perform copy operation, further comprises:
instructing the personal video recorder to execute the copy operation;
select copy source and destination;
confirming the copy destination having sufficient capacity for copying the data to be copied;
confirming the copy destination having a folder for saving the copied data; and
executing the copy operation.

10. The method of claim 1, wherein when the multimedia viewer instructs the personal video recorder to execute printing operation, further comprises the following steps:
instructing the personal video recorder to execute printing operation;
selecting a printed data;
setting up a printing time; and
executing printing operation according to the printing time.

11. The method of claim 1, wherein when the multimedia viewer instructs the personal video recorder to perform editing operation, further comprises the following steps:
instructing the personal video recorder to execute editing operation;
selecting a data to be edited;
confirming that the multimedia viewer has a capacity larger than the selected data; and
executing editing operation.

12. The method of claim 1, wherein when the multimedia viewer instructs the personal video recorder to perform history checking operation, further comprises the following steps:
instructing the personal video recorder to execute history checking operation;
selecting a record type to be checked;
inputting data of the record to be checked; and
outputting the checking result.

13. A digitized wireless remote control apparatus for a personal video recorder, using a multimedia viewer to digitally and remotely control a personal video recorder, comprising:
a central processor for processing execution all operations of the personal video recorder;
a TV tuner for receiving TV channel signals via satellite transmission;
a wireless interface module for transmitting and receiving wireless signals; and
a signal codec for decoding signals input from the multimedia viewer or outputting an encoded signal to the multimedia viewer.

14. The apparatus of claim 13, wherein the central processor comprises:
a MPEG codec for decoding an input image signal and outputting the decoded image signal;
a JPEG codec for decoding an input graphic signal and outputting the decoded graphic signal; and
a clock module for coordinating operation of the central processing unit.
